(19) United States
(12) Patent Application Publication
(10) Pub. No.: US 2025/0149606 A1
(43) Pub. Date: May 8, 2025

(54) MULTI-MODULE FUEL CELL SYSTEM AND METHOD OF CONTROLLING THE SAME

(71) Applicants: Hyundai Motor Company, Seoul (KR); Kia Corporation, Seoul (KR)

(72) Inventors: Ji Hee Jun, Yongin-si (KR); Jai Hyun Ahn, Seoul (KR); Won Sik Jeong, Pyeongtaek-si (KR)

(21) Appl. No.: 18/652,062

(22) Filed: May 1, 2024

(30) Foreign Application Priority Data
Nov. 6, 2023 (KR) 10-2023-0152113

(51) Int. Cl. H01M 8/04746; H01M 8/04111; H01M 8/04223; H01M 8/0444

(52) U.S. Cl. CPC H01M 8/04753; H01M 8/04111; H01M 8/04231; H01M 8/0444; H01M 8/04776

(57) ABSTRACT

A multi-module fuel cell system capable of preventing backflow of purged hydrogen may include a plurality of fuel cell modules each including an air compressor, an air inlet valve, an air outlet valve, and a fuel cell stack, a discharge pipe interconnecting air outlet portions of the plurality of fuel cell modules to allow at least one of air or hydrogen discharged from the plurality of fuel cell modules to flow therethrough, and a controller configured to determine whether at least one of the plurality of fuel cell modules requires hydrogen purge, to calculate a purge pressure of a fuel cell module requiring hydrogen purge, and to calculate an air discharge pressure of a remaining fuel cell modules based on the calculated purge pressure.

### CROSS-REFERENCE TO RELATED APPLICATIONS

This application claims priority from Korean Patent Application No. 10-2023-0152113, filed on Nov. 6, 2023, in the Korean Intellectual Property Office, the disclosure of which is incorporated herein by reference in its entirety.

### TECHNICAL FIELD

The present disclosure relates to a multi-module fuel cell system and a method of controlling the same.

### BACKGROUND

A fuel cell is a device that receives hydrogen and air from the outside and generates electrical energy through an electrochemical reaction in a fuel cell stack. Such a fuel cell may be used as a power source in various fields, such as fuel cell electric vehicles (FCEVs) or fuel cells for power generation.

A fuel cell system includes a fuel cell stack in which a plurality of unit cells used as a power source is stacked, a fuel supply system configured to supply hydrogen as fuel to the fuel cell stack, an air supply system configured to supply oxygen as an oxidizing agent required for electrochemical reaction, and a thermal management system configured to control the temperature of the fuel cell stack.

The fuel supply system depressurizes compressed hydrogen in a hydrogen tank and supplies the hydrogen to an anode (fuel electrode) of the fuel cell stack. The air supply system operates an air compressor to supply suctioned outside air to a cathode (air electrode) of the fuel cell stack.

When hydrogen is supplied to the fuel electrode of the fuel cell stack and oxygen is supplied to the air electrode of the fuel cell stack, hydrogen ions are separated by catalytic reaction from the fuel electrode. The separated hydrogen ions are transmitted to an oxidizing electrode, which is the air electrode, through an electrolyte membrane, and the hydrogen ions separated from the fuel electrode create electrochemical reaction with electrons and oxygen at the oxidizing electrode to obtain electrical energy.

A discharge device is provided to discharge byproducts, such as vapor, water, and heat, generated in an electrical energy generating process of the fuel cell stack and unreacted hydrogen and oxygen, and gases such as vapor, hydrogen, and oxygen are discharged to the atmosphere through a discharge pipe.

A multi-module fuel cell system includes a plurality of fuel cell modules to produce power. The plurality of fuel cell modules shares a single discharge pipe, and gases discharged from the respective fuel cell modules are discharged to the outside through the single discharge pipe.

In particular, a portion of hydrogen supplied to the fuel cell module is recirculated to the anode of the fuel cell stack. When hydrogen concentration is lowered below a predetermined level, the hydrogen is discharged to the outside through the discharge pipe. This is called hydrogen purge.

However, because the plurality of fuel cell modules shares one discharge pipe, hydrogen purged from one fuel cell module may flow into another fuel cell module connected thereto via the discharge pipe, which may cause serious damage to the durability of the fuel cell stack.

The information disclosed in this Background section is only for enhancement of understanding of the general background of the disclosure, and should not be taken as an acknowledgement or any form of suggestion that this information forms the related art or prior art already publicly known, available, or in use.

### SUMMARY

The present disclosure relates to a multi-module fuel cell system and a method of controlling the same.

Some embodiments of the present disclosure has been developed in view of the above problems, and some embodiments of the present disclosure provide a multi-module fuel cell system capable of preventing hydrogen purged from one fuel cell module from entering another fuel cell module, and a method of controlling the multi-module fuel cell system.

In accordance with an embodiment of the present disclosure, the above and other advantages can be accomplished by the provision of a multi-module fuel cell system including a plurality of fuel cell modules. Each of the fuel cell modules includes an air compressor, an air inlet valve, an air outlet valve, and a fuel cell stack. A discharge pipe interconnects air outlet portions of the plurality of fuel cell modules to allow one of or both air or hydrogen discharged from the plurality of fuel cell modules to flow therethrough. A controller is configured to determine that a first fuel cell module of the plurality of fuel cell modules requires hydrogen purge, to determine a purge pressure of the first fuel cell module, and to determine an air discharge pressure for each of a subset of the plurality of fuel cell modules based on the determined purge pressure of the first fuel cell module. The subset excludes the first fuel cell module.

The controller may be configured to determine that the first fuel cell module requires hydrogen purging using a measurement provided by a hydrogen concentration sensor in the first fuel cell module, to determine the purge pressure using the measurement provided by the hydrogen concentration sensor of the first fuel cell module, and to control one of or any combination of an inlet degree of opening of the air inlet valve, an outlet degree of opening of the air outlet valve, and a speed of the air compressor for each of the subset of the plurality of fuel cell modules, so that a hydrogen purge of the first fuel cell module can be performed at the determined purge pressure.

The controller may be configured to determine a difference between the purge pressure of the first fuel cell module and a pressure loss caused by a moving distance of purged hydrogen in the discharge pipe to determine a target air discharge pressure for each of the subset of the plurality of fuel cell modules.

The controller may be configured to control one of or both of an outlet degree of opening of the air outlet valve and a speed of the air compressor for each of the subset of the plurality of fuel cell modules, so that air discharge for each of the subset of the plurality of fuel cell modules is performed at the determined target air discharge pressure or higher for each of the subset of the plurality of fuel cell modules.

The controller may be further configured to control the speed of the air compressor to a minimum speed at which the air discharge is performed at the determined target air discharge pressure or higher for each of the subset of the plurality of fuel cell modules.

The controller may be configured to control an inlet degree of opening of the air inlet valve for each of the subset of the plurality of fuel cell modules so that a flow amount of air enabling production of output required by the fuel cell stack is introduced into the fuel cell stack for each of the subset of the plurality of fuel cell modules.

The plurality of fuel cell modules may be connected to each other in series or in parallel via the discharge pipe.

The controller may be configured to determine a flow pressure at a point of the discharge pipe in which a mixture of purged hydrogen and discharged air moves based on a current air discharge pressure of a second fuel cell module of the subset of the plurality of fuel cell modules connected in series to the first fuel cell module, and based on the purge pressure of the first fuel cell module.

The controller may be configured to determine a third air discharge pressure of a third fuel cell module of the subset of the plurality of fuel cell modules connected in parallel to the first fuel cell module based on the determined flow pressure and pressure loss of the flow pressure in the discharge pipe.

The plurality of fuel cell modules may be connected in parallel to each other via the discharge pipe.

The controller may be configured to determine an air discharge pressure of the subset of the plurality of fuel cell modules based on the purge pressure and pressure loss of the purge pressure in the discharge pipe.

In accordance with an embodiment of the present disclosure, a method of controlling a multi-module fuel cell system includes determining that a first fuel cell module of a plurality of fuel cell modules requires hydrogen purging, determining a purge pressure of the first fuel cell module, and determining an air discharge pressure for each of a subset of the plurality of fuel cell modules based on the determined purge pressure of the first fuel cell module, wherein the subset excludes the first fuel cell module.

The method may further include measuring a hydrogen concentration in the first fuel cell module, wherein the determining of the purge pressure comprises determining the purge pressure using the measured hydrogen concentration.

The determining of the air discharge pressure may include determining a difference between the purge pressure and pressure loss caused by a moving distance of purged hydrogen in a discharge pipe.

After the determining of the air discharge pressure, the method may further include controlling one of or any combination of a speed of an air compressor, an inlet degree of opening of an air inlet valve, and an outlet degree of opening of an air outlet valve, in each of the plurality of fuel cell modules to satisfy the determined purge pressure and the determined air discharge pressures.

### BRIEF DESCRIPTION OF THE DRAWINGS

The above and other features and advantages of the present disclosure can be more clearly understood from the following detailed description taken in conjunction with the accompanying drawings, in which:

FIG. 1 is a diagram that illustrates a multi-module fuel cell system according to an embodiment of the present disclosure;

FIG. 2 is a diagram that illustrates a multi-module fuel cell system according to an embodiment of the present disclosure; and

FIG. 3 is a flowchart that illustrates a multi-module fuel cell system control method according to an embodiment of the present disclosure.

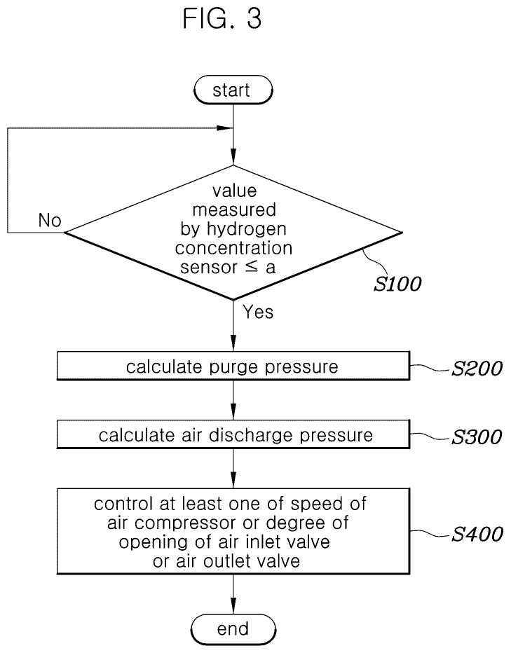

### DETAILED DESCRIPTION OF ILLUSTRATIVE EMBODIMENTS

Hereinafter, some embodiments disclosed in the present specification will be described in detail with reference to the accompanying drawings, and same or similar elements can be denoted by same reference numerals even though they can be depicted in different drawings, and redundant descriptions thereof can be omitted.

In the following description of some embodiments disclosed in the present specification, a detailed description of known functions and configurations incorporated herein can be omitted when the same may make the subject matter of the embodiments disclosed in the present specification rather unclear. In addition, the accompanying drawings are provided only for a better understanding of some embodiments disclosed in the present specification and are not intended to necessarily limit technical ideas disclosed in the present specification.

It can be understood that although the terms “first”, “second”, etc., may be used herein to describe various components, these components are not necessarily limited by such terms. Such terms can be merely used to distinguish one component from another component.

The terms “determined” and “calculated” may be interchanged in some embodiments or used interchangeably in describing some embodiments, because a value may be determined by a look-up table in a database or memory, a value may be calculated using an equations, or combinations thereof, to achieve equivalent or same data points by a controller, for example.

As used herein, a singular form can be intended to include plural forms as well, unless the context clearly indicates otherwise.

It can be further understood that the terms “comprises”, “comprising”, “includes”, and/or “including”, when used herein, specify the presence of stated features, integers, steps, operations, elements, components, or combinations thereof, but do not preclude the presence or addition of one or more other features, integers, steps, operations, elements, components, or combinations thereof.

It can be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

To control the function peculiar thereto, a controller may include a communication device, or a plurality thereof, which communicates with other controllers or sensors, a memory, or a plurality thereof, which can store therein an operating system, logic commands, and input/output information, and one or more processors, which can perform determinations, calculations, and decisions necessary or used for control of a given function.

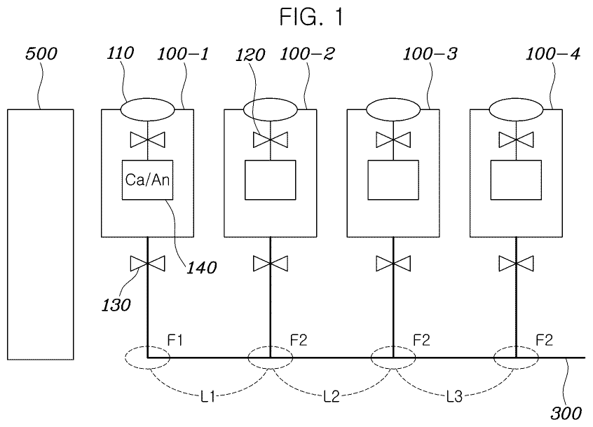

FIG. 1 is a multi-module fuel cell system according to an embodiment of the present disclosure. A multi-module fuel cell system according to an embodiment of the present disclosure includes a plurality of fuel cell modules 100. In detail, each of the plurality of fuel cell modules 100 includes an air compressor 110, an air inlet valve 120, an air outlet valve 130, and a fuel cell stack 140. In addition, the fuel cell modules 100 shown in FIG. 1 are connected in parallel to each other through a discharge pipe 300, which will be described later.

The air compressor 110 can supply air to a cathode of the fuel cell stack 140. The air compressor 110 can rotate at high speed to supply air to the cathode upon receiving a command from a controller 500 to produce power required by an external load.

The air inlet valve 120 can be a valve configured to control the flow rate of air flowing into an inlet of the cathode of the fuel cell stack 140, and can be generally referred to as an “ACV”. The air inlet valve 120 can be provided on the upstream side of the inlet of the cathode of the fuel cell stack 140, and may control the flow rate or pressure of air introduced into the cathode of the fuel cell stack 140 depending on the degree of opening thereof.

The air outlet valve 130 can be provided in or inline with the discharge pipe 300. The air outlet valve 130 can be a valve configured to control the flow rate or pressure of air that has passed through the cathode of the fuel cell stack 140 or air that has bypassed the fuel cell stack 140, and can be generally referred to as an “APC”. The air outlet valve 130 may control the flow rate or pressure of hydrogen purged from an anode as well as air, together or independently.

A hydrogen discharge valve can be provided on the upstream side of the anode of the fuel cell module 100. When the hydrogen discharge valve is opened by the controller 500, hydrogen to be purged may move to the discharge pipe 300, and may mix with air that has passed through the cathode of the fuel cell stack 140 or air that has bypassed the fuel cell stack 140 in the discharge pipe 300. Then, the mixture of hydrogen and air may be purged through the discharge pipe 300.

The plurality of fuel cell modules 100 is connected to each other via the single discharge pipe 300. In detail, air outlet portions, through which air that has passed through or bypassed around the fuel cell stacks 140 provided in the respective fuel cell modules 100 is discharged, are connected to each other or merge together via the discharge pipe 300.

Hydrogen can be recirculated to the anode, and the hydrogen concentration at the anode can be lowered by the recirculated hydrogen. When the hydrogen concentration is lowered below a threshold or predetermined level, the hydrogen in the anode can pass through the discharge pipe 300 together with air through the air outlet portion, and can be discharged to the outside.

The purged hydrogen flowing through the discharge pipe 300 may flow to another fuel cell module 100. The direction of flow of gas flowing through the discharge pipe 300 can be determined by the pressure of the gas. Therefore, if the pressure of the purged hydrogen is higher than the pressure of air discharged from another fuel cell module 100, there is a possibility that the purged hydrogen may flow back to the other fuel cell module 100 while pushing the air discharged from the other fuel cell module 100.

If the purged hydrogen flows back to another fuel cell module 100 through the discharge pipe 300, the purged hydrogen flows into the cathode of the fuel cell stack 140 and reacts with oxygen contained in air in the cathode, which may cause significant degradation of a cell catalyst layer of the fuel cell stack 140 and can result in serious damage to the durability of the fuel cell stack 140.

To prevent this problem, i.e., to prevent purged hydrogen from flowing backwards into another fuel cell module 100, the controller 500 can perform control such that the discharge pressure of air discharged from the other fuel cell module 100 is equal to or higher than the purge pressure of purged hydrogen, for example.

The controller 500 may be an integrated controller capable of individually controlling the respective fuel cell modules 100. Alternatively, the controller 500 may include sub-controllers configured to individually control the respective fuel cell modules and a main controller configured to control the sub-controllers, thereby controlling the components of the respective fuel cell modules through the sub-controllers.

In addition, the purge pressure can be determined based on the hydrogen concentration measured by a hydrogen concentration sensor provided in the fuel cell stack 140. The hydrogen concentration sensor can measure the hydrogen concentration at the anode of the fuel cell stack 140, and can transmit information about the measured hydrogen concentration to the controller 500. Upon determining that the hydrogen concentration has been lowered below a threshold or predetermined value, the controller 500 can perform purge of hydrogen.

The purge amount may be determined depending on the hydrogen concentration, and the purge pressure may be determined according to the purge amount. The relationship between the hydrogen concentration, the purge amount, and the purge pressure may be determined by calculation or determined by looked up using a data map or the like created in advance through tests, for example. In addition, the hydrogen concentration may also be determined or calculated through a concentration estimator as control logic. When the purge pressure is determined, the hydrogen discharge valve can be opened by the controller 500 to purge hydrogen at the determined purge pressure, and the speed of the air compressor 110 and the degree of opening of the air outlet valve 130 can be controlled based thereon.

Hereinafter, the multi-module fuel cell system shown in FIG. 1 will be described based on an assumption that a fuel cell module 100-1 performs or requires hydrogen purge and the remaining fuel cell modules 100-2, 100-3, and 1004 discharge air, as an example scenario. If the purge pressure in the fuel cell module 100-1 is determined to be A1, the remaining fuel cell modules 100-2, 100-3, and 100-4 may need to discharge air at the pressure of A1 or greater to prevent the hydrogen purged from the fuel cell module 100-1 from flowing back to the remaining fuel cell modules 100-2, 100-3, and 100-4.

However, if the air discharge pressure becomes much higher than the purge pressure, the purged hydrogen may flow back to the fuel cell module performing hydrogen purge. Therefore, it is preferable that the air discharge pressure of the fuel cell module performing air discharge be close to the purge pressure.

The direction of the discharged gas is guided by the discharge pipe 300, and a mixture of the purged hydrogen and the air may be easily discharged to the outside by gases continuously discharged from the fuel cell modules 100.

Gases flowing in the discharge pipe 300 can undergo pressure loss due to friction with the discharge pipe 300. Thus, hydrogen purged from the fuel cell module 100 undergoes pressure loss while moving through the discharge pipe 300. The pressure of the hydrogen purged from the fuel cell module 100 gradually decreases until the hydrogen is discharged to the outside through the discharge pipe 300. It is preferable for the fuel cell module 100 discharging air to determine or calculate the air discharge pressure in consideration of pressure loss of the hydrogen purge pressure.

Referring to FIG. 1, when hydrogen is purged from the fuel cell module 100-1 at a pressure of A1, the fuel cell module 100-2 may discharge air at a pressure of A2, which is lower than A1, in consideration of pressure loss caused by the moving distance of the purged hydrogen. The fuel cell module 100-3 may discharge air at a pressure of A3, which is lower than A2, and the fuel cell module 100-4 may discharge air at a pressure of A4, which is lower than A3.

Pressure loss caused by the moving distance of the purged hydrogen (including air mixed therewith) is first determined or calculated, and the air discharge pressures A2, A3, and A4 are determined or calculated by subtracting or considering the pressure loss caused by the moving distance of hydrogen from A1.

In other words, A2 can be obtained by subtracting pressure loss ΔP_{1,2} caused by a moving distance L1 of the purged hydrogen in the discharge pipe 300 from the purge pressure of A1 (A2=A1-ΔP_{1,2}). Similarly, A3 can be obtained based on pressure loss ΔP_{1,3} caused by a moving distance L1+L2 of the purged hydrogen in the discharge pipe 300 (A3=A1-ΔP_{1,3}), and A4 can be obtained based on pressure loss ΔP_{1,4} caused by a moving distance L1+L2+L3 of the purged hydrogen in the discharge pipe 300 (A4=A1-ΔP_{1,4}).

Pressure loss may be generally calculated using Fanning's formula below:

$$Δ P = λ \cdot \frac{L}{D} \cdot \frac{γ v}{2}$$

λ: coefficient of friction of pipe
L: length of pipe (m)
D: inner diameter of pipe (m)
Y: gas density in pipe (kg/m²)
v: flow rate in pipe (m/s).

In FIG. 1, when hydrogen is purged at a pressure of a2 from the fuel cell module 100-2, the fuel cell module 100-3 may discharge air at a pressure of a3, which is lower than a2, in consideration of pressure loss caused by a moving distance of the purged hydrogen. The fuel cell module 100-4 may discharge air at a pressure of a4, which is lower than a3.

The air discharge pressure of the fuel cell module 100-1 may be determined or calculated in consideration of the purge pressure a2 and pressure loss caused by the moving distance L1 of the discharged air. When a value obtained by subtracting the pressure loss ΔP_{1,2} from the air discharge pressure a1 of the fuel cell module 100-1 is equal to or greater than a2, backflow of the air to the fuel cell module 100-1 may be prevented. Therefore, the minimum value of the air discharge pressure a1 may be set to a sum of the purge pressure a2 and the pressure loss ΔP_{1,2} (a1=a2+ΔP_{1,2}).

In addition, when the discharge pipe 300 includes a point having a certain curvature, the controller 500 may calculate pressure loss in a curved pipe using a calculation formula for pressure loss in a curved pipe.

Further, it is preferable to calculate the air discharge pressure of the air outlet portion of the fuel cell module 100 in further consideration of pressure loss caused by movement of the air discharged from the fuel cell module 100 to points F2, F3, and F4 of the discharge pipe 300, at which the discharged air joins the purged hydrogen. Furthermore, it is preferable to calculate the air discharge pressure in further consideration of pressure loss caused by movement of the purged hydrogen to a point F1 of the discharge pipe 300.

The controller 500 may control the degree of opening of the air discharge valve 130 and/or the speed of the air compressor 110 so that air is discharged at a pressure equal to or higher than the air discharge pressure calculated through the above-described series of processes.

In an embodiment, the controller 500 may control the speed of the air compressor 110 to a minimum speed at which air is discharged at the calculated air discharge pressure. The controller 500 may control the speed of the air compressor 110 and/or the degree of opening of the air outlet valve 130 such that the speed of the air compressor 110 becomes a minimum RPM at which the calculated air discharge pressure is formed and/or such that the air discharge valve 130 is opened to a minimum degree so that air is discharged through the discharge pipe 300 at the calculated air discharge pressure.

Hydrogen purge may need to be performed in some fuel cell modules 100, and power generation may need to be continuously performed in some fuel cell modules 100. The controller 500 may not only control the air compressor 110 and the air outlet valve 130, which constitute the fuel cell module 100, to discharge air at the calculated air discharge pressure, but may also control the degree of opening of the air inlet valve 120 so that the flow amount of air capable of producing output required by the fuel cell stack 140 is introduced into the fuel cell stack 140.

The air inlet valve 120 may not be directly involved in formation of the air discharge pressure, but the degree of opening thereof may be controlled to satisfy the flow amount of air that needs to be introduced into the fuel cell stack 140. Because the speed of the air compressor 110 can be controlled to satisfy the air discharge pressure, the air inlet valve 120 may be controlled to satisfy the target flow amount of air based on the determined speed of the air compressor 110.

In detail, an air flow sensor configured to measure the flow amount of air may be provided in the fuel cell stack 140. The controller 500 may compare the actual flow amount of air flowing into the fuel cell stack 140 with the target flow amount of air for power generation, and may perform feedback control on the degree of opening of the air inlet valve 120 so that the actual flow amount of air flowing into the fuel cell stack 140 follows the target flow amount of air.

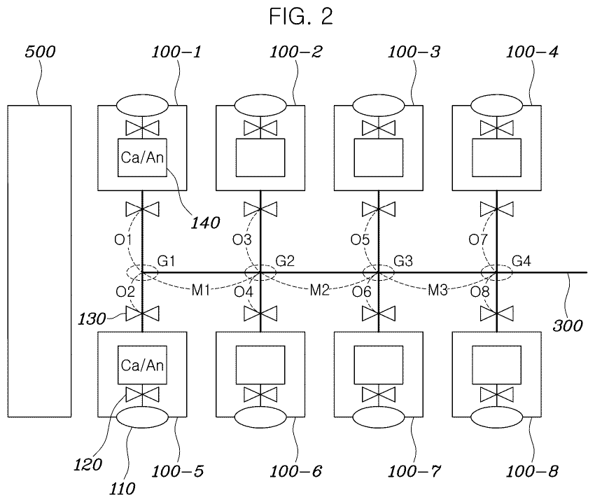

Although the multi-module fuel cell system is illustrated in FIG. 1 as being configured such that the fuel cell modules 100 are connected in parallel to each other, the fuel cell modules 100 may be connected to each other in series, in parallel, or in combinations thereof. As shown in FIG. 2, the fuel cell modules 100 may be connected to each other in series or in parallel via the discharge pipe 300.

Even when the fuel cell modules 100 are placed as shown in FIG. 2, the air discharge pressure of each of the fuel cell modules 100 may be determined/calculated based on the purge pressure of hydrogen.

In detail referring to FIG. 2 as an example configuration and scenario, the controller 500 first determines or identifies a fuel cell module 100 that requires hydrogen purge. Thereafter, upon determining a fuel cell module 100 requiring hydrogen purge, the controller 500 may calculate a flow pressure in a point (one of G1, G2, G3, and G4) of the discharge pipe 300, at which purged hydrogen and discharged air mix each other and move, based on the air discharge pressure and the hydrogen purge pressure of a fuel cell module 100 connected in series to the fuel cell module 100 requiring hydrogen purge via the discharge pipe 300.

For example, assuming that hydrogen purge is performed in a fuel cell module 100-1, the greatest purge pressure is applied to a fuel cell module 100-5, which faces the fuel cell module 100-1 and is connected in series thereto at the point G1. Thus, there is the highest possibility that air flows back to the fuel cell module 100-5. Therefore, the fuel cell module 100-5 may need to discharge air at a pressure higher than the purge pressure of the fuel cell module 100-1.

The target air discharge pressure of the fuel cell module 100-5 may be set to a value similar to the hydrogen purge pressure of the fuel cell module 100-1. When the target air discharge pressure of the fuel cell module 100-5 is set, the air inlet valve 120, the compressor 110, and the air outlet valve 130 of the fuel cell module 100-5 may be controlled based thereon.

First, an expected purge pressure is determined/calculated during purge of the fuel cell module 100-1. As described above, an expected purge amount can be determined/calculated using a data map based on the hydrogen concentration calculated through the concentration estimator, and an expected purge pressure is determined/calculated based on the calculated expected purge amount.

To prevent backflow of hydrogen, the fuel cell module 100-5 and the other fuel cell modules can be controlled based on a difference between the expected purge pressure of the fuel cell module 100-1 and the air discharge pressure of the fuel cell module 100-5 at the point G1.

In detail, when hydrogen purge is performed in the fuel cell module 100-1, the expected pressure acting on the point G1 is calculated as follows.

$$Expected Pressure at Point G 1 = ( Expected Purge Pressure of Fuel Cell Module 100 - 1 \times \frac{O 2}{O 1 + O 2} ) - ( Current Pressure of Fuel Cell Module 100 - 5 \times \frac{O 1}{O 1 + O 2} )$$

The expected pressure acting on the point G1 may be calculated as above through the relationship between the length O1 of the pipe from the point G1 to the fuel cell module 100-1 and the length O2 of the pipe from the point G1 to the fuel cell module 100-5. In addition, for accurate measurement, it is preferable to measure the current pressure of the fuel cell module 100-5 in a state of fully opening the air outlet valve 130 of the fuel cell module 100-5. A pressure sensor provided on the upstream side of the air outlet valve 130 can be used as a measurement sensor.

When hydrogen purge is expected at the point G1, the expected pressure can be calculated using the above equation, and can be set to the target air discharge pressure of the fuel cell module 100-5.

To realize the target air discharge pressure of the fuel cell module 100-5, the operating RPM of the compressor 110 can be increased to a certain extent to increase the pressure of the supplied air. Then, feedback control can be performed on the air inlet valve 120 to reduce the flow amount of air increased by the increased RPM of the compressor 110 to required normal flow amount of air. Accordingly, the discharge pressure of air can be increased while the flow amount of air is maintained. Feedback control can be performed on the degree of opening of the air outlet valve 130 to realize the target air discharge pressure of the fuel cell module 100-5.

The controller 500 may control the speed of the air compressor 110, the degrees of opening of the air inlet valve 120, the air outlet valve 130, or any combination thereof, of each of fuel cell modules 100-2 and 100-6 so that the pressure at the point G2, at which air discharged from the fuel cell module 100-2 and air discharged from the fuel cell module 100-6 mix with each other, also becomes higher than the flow pressure.

Similarly, the controller 500 may control the speed of the air compressor 110, the degrees of opening of the air inlet valve 120, the air outlet valve 130, or any combination thereof, of each of fuel cell modules 100-3 and 100-7 so that the pressure at the point G3, at which air discharged from the fuel cell module 100-3 and air discharged from the fuel cell module 100-7 mix with each other, becomes higher than the flow pressure. In addition, the controller 500 may control at least one of the speed of the air compressor 110 or the degrees of opening of the air inlet valve 120, and the air outlet valve 130, of each of fuel cell modules 100-4 and 100-8 so that the pressure at the point G4, at which air discharged from the fuel cell module 100-4 and air discharged from the fuel cell module 100-8 mix with each other, becomes higher than the flow pressure.

The pressures at the points G2, G3, and G4 may be obtained by calculating the air discharge pressure and pressure loss in the pipe, similar to the method of calculating the flow pressure of the mixture of gases from the fuel cell modules 100-1 and 100-5.

Accordingly, the multi-module fuel cell system shown in FIG. 2, in which the fuel cell modules are connected to each other in parallel or in series, may also prevent backflow of purged hydrogen according to an embodiment of the present disclosure.

The flow pressure of a gas mixture of purged hydrogen and discharged air is lost as the gas mixture flows through the discharge pipe. Therefore, when calculating the air discharge pressure, it can be necessary to consider flow pressure loss due to flow of the gas mixture through the discharge pipe.

Hereinafter, the multi-module fuel cell system shown in FIG. 2 will be described as an example. It is assumed that hydrogen is purged from the fuel cell module 100-1 and the pressure formed at the point G1 by a mixture of the purged hydrogen and air discharged from the fuel cell module 100-5 is B1, as an example scenario.

The air discharge pressures of the fuel cell modules 100-2 and 100-6 may be determined in consideration of pressure loss caused by the moving distance M1 of a gas mixture of the hydrogen purged from the fuel cell module 100-1 and the air discharged from the fuel cell module 100-5.

When the pressure loss caused by the moving distance M1 of the gas mixture in the discharge pipe is ΔQ_{1,2}, the controller 500 may control the speed of the air compressor 110 or the degree of opening of the air outlet valve 130 of each of the fuel cell modules 100-2 and 100-6 so that the pressure formed at the point G2 by a mixture of air discharged from the fuel cell module 100-2 and air discharged from the fuel cell module 100-6 becomes higher than “B1-ΔQ_{1,2}”.

This control process may be equally applied to the fuel cell modules 100-3 and 100-7 and to the fuel cell modules 100-4 and 100-8, and the pressure loss may be calculated using Fanning's formula as described above. In addition, when the discharge pipe includes a point having a certain curvature, the controller 500 may calculate an air discharge pressure in consideration of pressure loss in a curved pipe using a calculation formula for pressure loss in a curved pipe.

It can be assumed that hydrogen is purged from the fuel cell module 100-2 and the pressure formed at the point G2 by a mixture of the purged hydrogen and air discharged from the fuel cell module 100-6 is b2, as an example scenario.

The air discharge pressures of the fuel cell modules 100-3 and 100-7 may be determined in consideration of pressure loss caused by the moving distance M2 of a gas mixture of the hydrogen purged from the fuel cell module 100-2 and the air discharged from the fuel cell module 100-6.

When the pressure loss caused by the moving distance M2 of the gas mixture in the discharge pipe is ΔQ_{2,3}, the controller 500 may control the speed of the air compressor 110 or the degree of opening of the air outlet valve 130 of each of the fuel cell modules 100-3 and 100-7 so that the pressure formed at the point G3 by a mixture of air discharged from the fuel cell module 100-3 and air discharged from the fuel cell module 100-7 becomes higher than “b2-ΔQ_{2,3}”.

When a gas mixture of air discharged from the fuel cell module 100-1 and air discharged from the fuel cell module 100-5 moves from the point G1 to the point G2, the pressure b1 of the gas mixture is lost by ΔQ_{1,2}. Considering the pressure loss of the pressure b1 of the gas mixture moving from the point G1, when the pressure b1 at the point G2 is equal to or higher than b2, backflow of the purged hydrogen to the fuel cell modules 100-1 and 100-5 is prevented. Therefore, the controller 500 may control the speed of the air compressor 110 or the degree of opening of the air outlet valve 130 of each of the fuel cell modules 100-1 and 100-5 so that the minimum value of the pressure b1 at the point G1 becomes “b2+ΔQ_{1,2}”.

A method of controlling a multi-module fuel cell system according to an embodiment of the present disclosure for accomplishing the above and other functions and advantages, includes an operation of determining, by the controller 500, whether at least one of the plurality of fuel cell modules 100 requires hydrogen purge (operation S100), an operation of calculating, by the controller 500, a purge pressure of a fuel cell module 100 requiring hydrogen purge when hydrogen purge is required (operation S200), and an operation of calculating, by the controller 500, an air discharge pressure of remaining fuel cell module(s) other than the fuel cell module requiring hydrogen purge based on the calculated purge pressure when hydrogen purge is required (operation S300).

In the operation S200 of calculating the purge pressure, the controller 500 may calculate the purge pressure using measurements or information from a hydrogen concentration sensor provided in each of the plurality of fuel cell modules 100. In detail, when a value measured by the hydrogen concentration sensor is equal to or less than a threshold, target, or predetermined value A, the controller 500 determines that hydrogen needs to be purged.

In the operation S300 of calculating the air discharge pressure, the controller 500 may calculate a difference between the purge pressure and pressure loss caused by a moving distance of purged hydrogen in the discharge pipe 300 to calculate the air discharge pressure of the remaining fuel cell modules 100.

The method may further include, after the operation S300 of calculating the air discharge pressure, an operation of controlling at least one of the speed of the air compressor 110 or the degree of opening of the air inlet valve 120 or the air outlet valve 130 provided in each of the plurality of fuel cell modules 100 to satisfy the calculated purge pressure and air discharge pressure (operation S400).

As can be apparent from the above description, according to a multi-module fuel cell system and a method of controlling the same of an embodiment of the present disclosure, it may be possible to prevent hydrogen purged from one fuel cell module from entering another fuel cell module (e.g., by undesired backflow), thereby improving the durability of the fuel cell module.

Although some embodiments of the present disclosure have been disclosed for illustrative purposes, those skilled in the art can appreciate that various modifications, additions, and substitutions can be possible, without departing from the scope and spirit of the present disclosure according to the accompanying claims.

What is claimed is:

1. A multi-module fuel cell system comprising:
a plurality of fuel cell modules, each of the fuel cell modules comprising an air compressor, an air inlet valve, an air outlet valve, and a fuel cell stack;
a discharge pipe interconnecting air outlet portions of the plurality of fuel cell modules to allow one of or both of air and hydrogen discharged from the plurality of fuel cell modules to flow therethrough; and
a controller configured to determine that a first fuel cell module of the plurality of fuel cell modules requires hydrogen purge, to determine a purge pressure of the first fuel cell module, and to determine an air discharge pressure for each of a subset of the plurality of fuel cell modules based on the determined purge pressure of the first fuel cell module, wherein the subset excludes the first fuel cell module.

2. The system of claim 1, wherein the controller is configured to determine that the first fuel cell module requires hydrogen purging using a measurement provided by a hydrogen concentration sensor in the first fuel cell module, to determine the purge pressure using the measurement provided by the hydrogen concentration sensor of the first fuel cell module, and to control one of or any combination of an inlet degree of opening of the air inlet valve, an outlet degree of opening of the air outlet valve, and a speed of the air compressor for each of the subset of the plurality of fuel cell modules, so that a hydrogen purge of the first fuel cell module can be performed at the determined purge pressure.

3. The system of claim 1, wherein the controller is configured to determine a difference between the purge pressure of the first fuel cell module and a pressure loss caused by a moving distance of purged hydrogen in the discharge pipe to determine a target air discharge pressure for each of the subset of the plurality of fuel cell modules.

4. The system of claim 3, wherein the controller is configured to control one of or both of an outlet degree of opening of the air outlet valve and a speed of the air compressor for each of the subset of the plurality of fuel cell modules, so that air discharge for each of the subset of the plurality of fuel cell modules is performed at the determined target air discharge pressure or higher for each of the subset of the plurality of fuel cell modules.

5. The system of claim 4, wherein the controller is further configured to control the speed of the air compressor to a minimum speed at which the air discharge is performed at the determined target air discharge pressure or higher for each of the subset of the plurality of fuel cell modules.

6. The system of claim 1, wherein the controller is configured to control an inlet degree of opening of the air inlet valve for each of the subset of the plurality of fuel cell modules so that a flow amount of air enabling production of output required by the fuel cell stack is introduced into the fuel cell stack for each of the subset of the plurality of fuel cell modules.

7. The system of claim 1, wherein the plurality of fuel cell modules is connected to each other in series or in parallel via the discharge pipe.

8. The system of claim 7, wherein the controller is configured to determine a flow pressure at a point of the discharge pipe in which a mixture of purged hydrogen and discharged air moves based on a current air discharge pressure of a second fuel cell module of the subset of the plurality of fuel cell modules connected in series to the first fuel cell module, and based on the purge pressure of the first fuel cell module.

9. The system of claim 8, wherein the controller is configured to determine a third air discharge pressure of a third fuel cell module of the subset of the plurality of fuel cell modules connected in parallel to the first fuel cell module based on the determined flow pressure and pressure loss of the flow pressure in the discharge pipe.

10. The system of claim 1, wherein the plurality of fuel cell modules is connected in parallel to each other via the discharge pipe.

11. The system of claim 10, wherein the controller is configured to determine an air discharge pressure of the subset of the plurality of fuel cell modules based on the purge pressure and pressure loss of the purge pressure in the discharge pipe.

12. A method of controlling a multi-module fuel cell system, the method comprising:
determining that a first fuel cell module of a plurality of fuel cell modules requires hydrogen purging;
determining a purge pressure of the first fuel cell module; and
determining an air discharge pressure for each of a subset of the plurality of fuel cell modules based on the determined purge pressure of the first fuel cell module, wherein the subset excludes the first fuel cell module.

13. The method of claim 12, further comprises measuring a hydrogen concentration in the first fuel cell module, wherein the determining of the purge pressure comprises determining the purge pressure using the measured hydrogen concentration.

14. The method of claim 12, wherein the determining of the air discharge pressure comprises determining a difference between the purge pressure and pressure loss caused by a moving distance of purged hydrogen in a discharge pipe.

15. The method of claim 12, further comprising, after the determining of the air discharge pressure, controlling one of or any combination of a speed of an air compressor, an inlet degree of opening of an air inlet valve, and an outlet degree of opening of an air outlet valve, in each of the plurality of fuel cell modules to satisfy the determined purge pressure and the determined air discharge pressures.
